(19) United States
(12) Patent Application Publication
(10) Pub. No.: US 2017/0001491 A1
(43) Pub. Date: Jan. 5, 2017

(54) VEHICULAR AIR CONDITIONER AND VEHICLE EQUIPPED WITH VEHICULAR AIR CONDITIONER

(71) Applicant: Valeo Japan Co., Ltd., Saitama (JP)

(72) Inventors: Yukio Suzuki, Saitama (JP); Hideki Nagano, Saitama (JP); Masayuki Murase, Saitama (JP)

(73) Assignee: Valeo Japan Co., Ltd., Saitama (JP)

(21) Appl. No.: 15/196,193

(22) Filed: Jun. 29, 2016

(30) Foreign Application Priority Data
Jul. 3, 2015 (JP) 2015-134312

(51) Int. Cl. B60H 1/00

(52) U.S. Cl. CPC B60H 1/00064; B60H 1/00678; B60H 1/00564; B60H 2001/006; B60H 2001/00135

(57) ABSTRACT

To provide a vehicular air conditioner provided with a partition portion splitting blowing sir absorbed into a casing into plural air flows and a door capable of abutting on the partition portion, in which an air volume from an air blow-off port is secured end generation of noise is reduced, and a vehicle equipped with the vehicular air conditioner. The vehicular air conditioner according to the present invention has the partition portion splitting the blowing air into plural air flows and having a cross-sectional shape which is smaller in an upstream side than in a downstream side of the blowing air.

### BACKGROUND OF THE INVENTION

### Field of the Invention

The present invention relates to a vehicular air conditioner provided with a partition portion splitting blowing air into plural sirs and a door capable of abutting on the partition portion in an air blow-off port from which the blowing air absorbed into a casing is blown off, and a vehicle equipped with the vehicular air conditioner.

More specifically, the present invention relates to a vehicular air conditioner provided with an air passage for sending the air absorbed from an air inlet to a blow-off opening inside a casing, air conditioning means such as a heat exchanger for cooling, a heat exchanger for heating, an air mix door and a blow-off mode switching door housed inside the air passage end a partition portion which partitions an air blow-off port into plural ports, on which the blow-off mode switching door abuts, in which the air blow-off port has a structure in which an air volume from the air blow-off port is secured and noise generated in the air blow-off port is reduced, and a vehicle equipped with the vehicular air conditioner.

### BACKGROUND ART

In the vehicular air conditioner, it has been required that an air volume is secured and that noise is reduced for improving the comfort in a vehicle inferior space. In particular, in a blower which is a large factor, a great deal of effort has been made for reducing the size, improving air blowing ability and reducing noise (Non-Patent Document 1).

Accordingly, in a common vehicular air conditioner in which an air flow passage for sending the air absorbed from the air inlet to the air blow-off port is provided, and air conditioning means such as the heat exchanger for cooling, the heat exchanger for heating, the air mix door and the blow-off mode switching door ere housed in the air flow passage, it is required to consider to secure the air volume and to reduce noise by reducing ventilation resistance formed by structures of respective parts in a casing.

For example, there is disclosed a formation of a structure such as dimples for suppressing a turbulent flow or an air separation phenomenon in portions where the turbulent flow or the air separation phenomenon relatively tend to occur in the air flow passage, the blow-off mode switching door and the like inside the casing (Patent Document 1).

On the other hand, though air blow-off ports provided with a partition portion for splitting blowing air absorbed into a casing into plural air flows and a door are formed in respective positions of the casing of the vehicular air conditioner, a structure in the vicinity of the air blow-off ports is just determined under constraints of a function of splitting the air flow into plural flows and the design of a mold for injection molding (Patent Document 2).

In particular, in a vehicular air conditioner having a partition portion which partitions the air blow-off port into plural blow-off ports (for example, a center ventilation opening and a side ventilation opening), on which a blow-mode switching door (for example, a defroster/ventilator switching door for switching between a defroster blow-off mode and a ventilator blow-off mode) abuts, in the air blow-off port from which the blowing air absorbed into the casing is blown off (for example, a ventilation opening), the structure of the air blow-off port is just determined under constraints of the function of splitting the air flow into plural flows and the design of the mold for injection molding, and the structure for securing the air volume and reducing noise has not been devised.
[Patent Document 1] JP-A-2006-151068
[Patent Document 2] JP-A-11-198638
[Non-Patent Document 1] SAKAI Masaharu et al.; “Noise Reduction of the Fans for Automobile Air-conditioning System”, DENSO TECHNICAL REVIEW, Vol. 10, No. 1 (2005) pp. 71 to 77

### SUMMARY OF THE INVENTION

An object of the present invention is to provide a vehicular air conditioner provided with a partition portion splitting blowing air absorbed into a casing into plural airs end a door capable of abutting on the partition portion, in which an air volume from an air blow-off port is secured and generation of noise is reduced, and a vehicle equipped with the vehicular air conditioner.

More specifically, the object of the present invention is to provide a vehicular air conditioner provided with an air passage for sending the air absorbed from an air inlet to a blow-off opening inside a casing, air conditioning means such as a heat exchanger for cooling, a heat exchanger for heating, an air mix door and a blow-off mode switching door housed inside the air passage and a partition portion which partitions the air blow-off port into plural ports, on which the blow-off mode switching door abuts, in which the air blow-off port has a structure in which an air volume from the air blow-off port is secured and noise generated in the air blow-off port is reduced, and a vehicle equipped with the vehicular air conditioner.

The present inventors have studied the structure of the air blow-off port having a partition portion splitting blowing air absorbed into a casing into plural airs and a door for solving the above problem, as a result, the present inventors have found that it is possible to reduce the reduction in air volume and the generation of noise by forming the partition portion to have a cross-sectional shape which is smaller in an upstream side than in a downstream side of the blowing air and have completed the present invention.

According to an embodiment of the present invention, there is provided a vehicular air conditioner capable of reducing the reduction in air volume and the generation of noise, which includes a casing provided wish an air passage of blowing air thereinside and including an air blow-off port from which the blowing air is blown off, a partition portion provided in the air blow-off port, splitting the blowing air into plural air flows and having a cross-sectional shape which is smaller in an upstream side than in a downstream side of the blowing air and a door arranged inside the air passage so as to rotate and capable of abutting on the partition portion.

More specifically, the vehicular air conditioner according to the embodiment of the present invention, an outer contour line showing the cross-sectional shape of the partition portion which is contacted by the blowing air may (1) extend to be widened to the end, (2) extend in an approximately V-shape, (3) extend in an approximately U-shape or (4) extend in an approximately trapezoidal shape from the upstream side to the downstream side of the air.

In the vehicular air conditioner according to the embodiment of the present invention, a plurality of ribs may be formed inside the partition portion.

In the vehicular air conditioner according to the embodiment of the present invention, the air blow-off port may be a ventilator blow-off port, and the partition portion may split the blowing air into airs flowing toward a center ventilation opening provided in the center of a vehicle, a right-side ventilation opening provided in the right side of the vehicle and a left-side ventilation opening provided in the left side of the vehicle.

In the vehicular air conditioner according to the embodiment of the present invention, the air blow-off port may be a ventilator blow-off port, and the door may be a defroster/ventilator door performing switching so that the blowing air is blown off from any of the ventilator blow-off port and a defroster blow-off port.

It is further preferable that plural ribs are formed inside the partition portion in the ventilator blow-off port.

Also according to an embodiment of the present invention, there is provided a vehicle equipped with the vehicular air conditioner according to one of the above forms.

According to the embodiments of the present invention, it is possible to reduce ventilation resistance and to prevent the reduction in air volume and the generation of noise by the cross-sectional shape of the partition portion which is smaller in the upstream side than in the downstream side.

### BRIEF DESCRIPTION OF THE DRAWINGS

FIG. 1 is a schematic view showing an external appearance of a vehicular air conditioner according to an embodiment of the present invention;

FIG. 2 is a schematic view showing a vehicular air conditioner according to another embodiment of the present invention in a cross section taken at approximately the center of the vehicular air conditioner in a left and right direction of the vehicle;

FIGS. 3A and 3B are schematic views showing a partition portion of a related-art ventilator blow-off port taken along a surface including I-I line in FIG. 1 and corresponding to a surface extending in a vertical direction of a vehicle and the right and left direction of the vehicle or taken along a surface corresponding to a surface extending in the vertical direction of the vehicle (a upper and lower direction on the paper) and the right and left direction of the vehicle (a depth direction on the paper) in ventilator blow-off ports in FIG. 2 in a related-art vehicular air conditioner, in which FIG. 3A shows a cross section and FIG. 3B shows a schematic view of the entire portion.

FIGS. 4A and 4B are schematic views showing cross sections of the vehicular air conditioner according to the present invention which are taken along the surface including I-I line in FIG. 1 and corresponding to the surface extending in the vertical direction of the vehicle and the right and left direction of the vehicle or taken along the surface corresponding to the surface extending in the vertical direction (the upper and lower direction on the paper) of the vehicle and the right and left direction (the depth direction on the paper) of the vehicle in the ventilator blow-off ports in FIG. 2, in which FIG. 4A shows a form where an outer contour line of a partition portion extends in an approximately V-shape from an upstream side to a downstream side of the air and FIG. 4B shows a form where the outer contour line extends to be widened to the end;

FIGS. 5A to 5C are schematic views showing the partition portion of the present invention, in which FIG. 5A shows a form having the approximately the same cross-sectional shape in the front and rear direction of the vehicle, FIG. 5B shows a form having different cross-sectional shapes and FIG. 5C shows another form having different cross-sectional shapes; and

FIGS. 6A and 6B are schematic views showing ventilator blow-off ports having the partition portion of she present invention, in which FIG. 6A shows a form of the partition portion having the approximately the same cross-sectional view in the front and rear direction of the vehicle and FIG. 6B shows a form of the partition portion having different cross-sectional shapes.

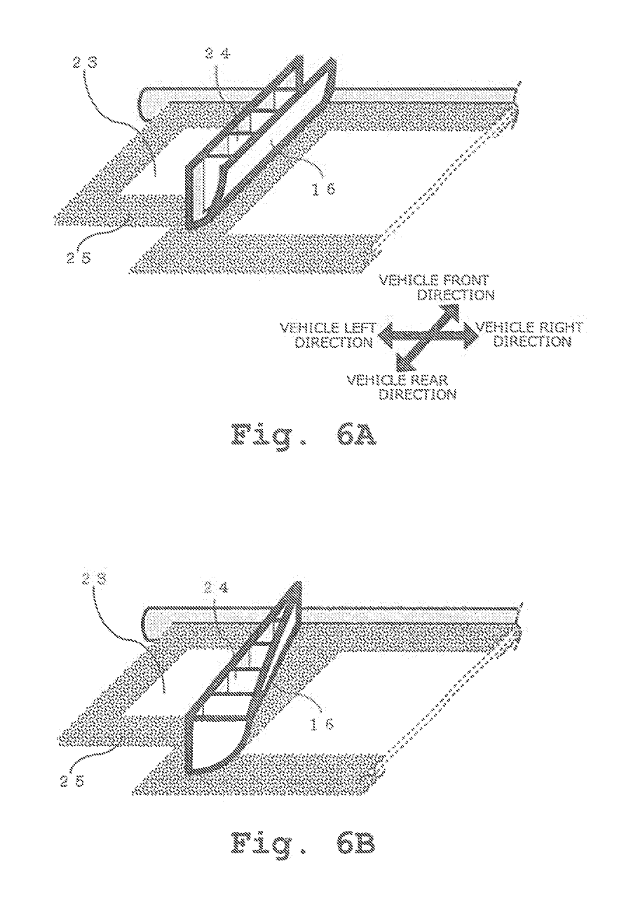

### DESCRIPTION OF THE PREFERRED EMBODIMENTS

Hereinafter, the present invention will be explained in detail based on embodiments shown in the drawings. The present invention is not limited to the embodiments and is specified by items described in claims.

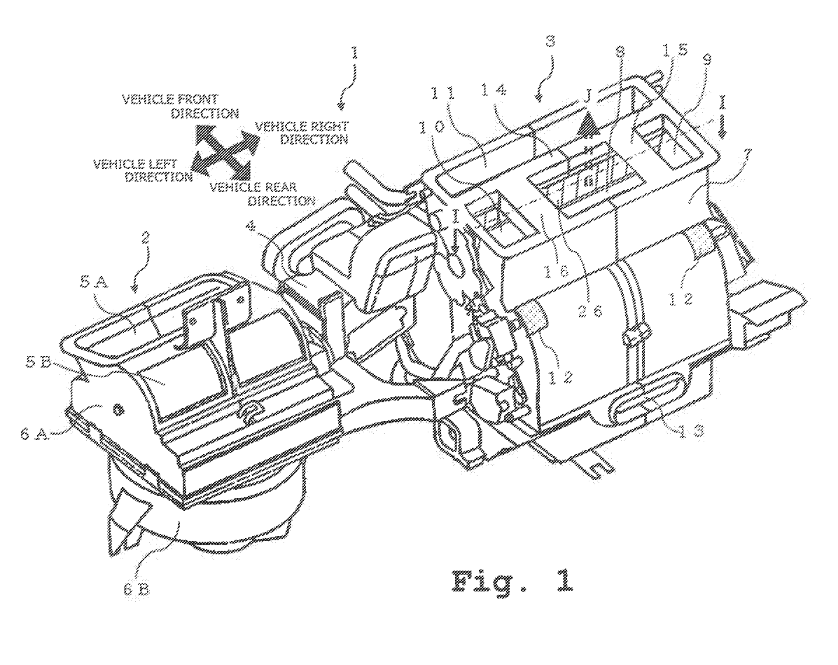

FIG. 1 shows an external appearance of a vehicular air conditioner 1 according to an embodiment of the present invention, which is a schematic view showing a horizontal air conditioner arranged so as to extend in a right and left direction of a vehicle.

A basic structure includes a blower unit 2 and an air conditioning unit 3. The blower unit 2 is communicated with the air conditioning unit 3 through an air blow duct 4. The blower unit 2 includes a blower unit upper case 6A in which an outside air inlet 5A and an inside air inlet 5B are suitably opened and an inside/outside switching door (not shown) for suitably selecting between the air introduced from the outside air inlet 5A and the air introduced from the inside air inlet 5B is housed, end a blower unit lower case 6B in which a blower (not shown) is housed.

On the other hand, the air conditioning unit 3 is arranged in the back side of a center console positioned in the center of the vehicle in the right and left direction (width direction). In an air passage Z of the blowing air formed inside a casing 7, a heat exchanger for cooling, a heat exchanger for heating, an air mix door, a defroster/ventilator door which are not shown are suitably provided. The casing 7 is formed of a resin material such as polypropylene with talc and an ABS resin which can be manufactured by a well-known injection molding process. As air blow-off ports from which the air is blown off, a center ventilation opening 8, a right-side ventilation opening 9, a left-side ventilation opening 10, a defroster blow-off port 11, front foot blow-off ports 12 and a rear foot blow-off port 13 are formed. The center ventilation opening 8 and the right-side ventilation opening 9 are partitioned by a right-side ventilation partition portion 15, and the center ventilation opening 8 and the left-side ventilation opening 10 are partitioned by a left-side ventilation partition portion 16, respectively. As described above, the center ventilation opening 8, the right-side ventilation opening 9 and the left-side ventilation opening 10 are formed by the partition portions 15 and 16 partitioning the ventilator blow-off ports (hereinafter, the center ventilation opening 8, the right-side ventilation opening 9 and the left-side ventilation opening 10 may be referred to as “ventilator blow-off ports 8, 9 and 10”). The ventilator blow-off ports 8, 9, 10 and the defroster blow-off port 11 are partitioned by a defroster partition portion 14.

In the blowing air blowing off from the ventilator blow-off pores 8, 9, 10 and the defroster blow-off port 11, the ratio of blowing air is controlled by defroster/ventilator door arranged in the air passage Z so as to be rotatable. When the ratio of blowing air blowing off from the defroster blow-off port 11 is controlled to the maximum, the defroster/ventilator door abuts on the partition portions 15 and 16.

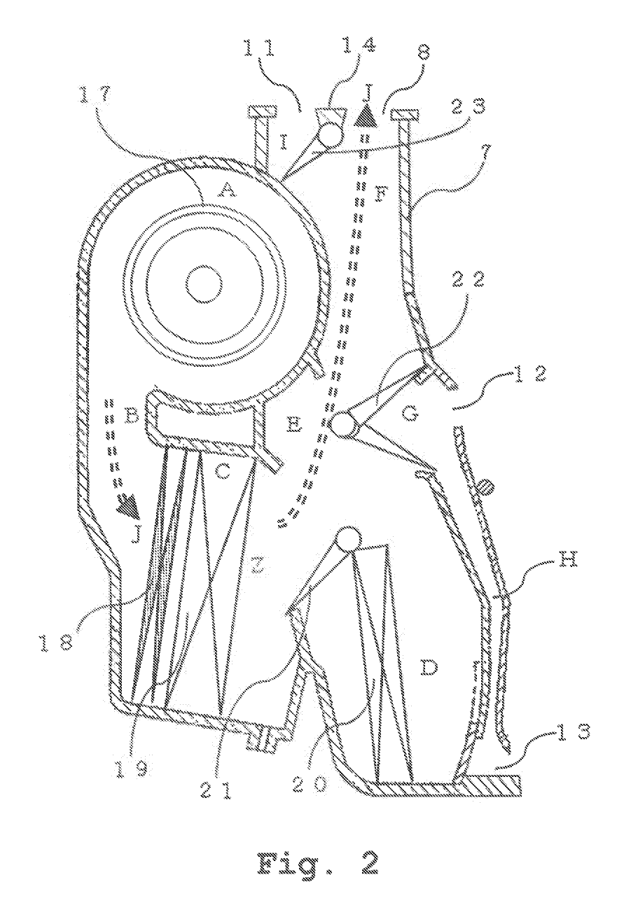

FIG. 2 shows the vehicular air conditioner 1 according to another embodiment of the invention, which is a schematic view of a vertical air conditioner in which components are arranged so as to be consolidated in a vertical direction of the vehicle in a cross section taken along a front and rear direction of the vehicle at approximately the center of the vehicular air conditioner 1 in the left and right direction of the vehicle.

The air passage Z for the blowing air is forced inside the casing 7, and plural casing parts are combined to configure the integrated casing 7. In the air passage Z, a blower 17, a filter 18, a heat exchanger for cooling 19, an air mix door 21, a heat exchanger for heating 20, a foot door 22 and a defroster/ventilator door 23 ore suitably arranged. A blowing air J is introduced from the outside of the casing 7 by the blower 17, flowing toward the defroster blow-off port 11 and the ventilator blow-off ports 8, 9 and 10 via a blower housing portion A, an air inlet passage B (air blow duct a heat exchanger for cooling setting space C in which the filter 18 and the heat exchanger for cooling 19 are set, a heat exchanger tor heating setting space D in which the heat exchanger for heating 20 is set end/or a heat exchanger for heating bypass passage E. The rate of air blowing off from the defroster 11 and the ventilator blow-off ports 8, 9 and 10 is controlled by the defroster/ventilator door 23. Part of the blowing air J may be guided to the front foot blow-off ports 12 or the rear foot blow-off port 13 by controlling the position of the defroster/ventilator door 23.

The ventilator blow-off ports 8, 9 and 10 of FIG. 2 (ports 9 and 10 are not shown in FIG. 2) are partitioned by the partition portions 15 and 16 in the same manner as the ventilator blow-off ports 8, 9 and 10 of FIG. 1, and the center ventilation opening 8, the right-side ventilation opening 9, the left-side ventilation opening 10 are formed. When the rate of the blowing air J blowing off from the ventilator blow-off ports 8, 9 and 10 is controlled to the minimum, the def roster/ventilator door 23 abuts on the partition portions 15 and 16 to thereby close the center ventilation opening 8 and prevent the passing of the blowing air J. On the other hand, the right-side ventilation opening 9 and the left-side ventilation opening 10 are previously formed so as not to be completely closed, thereby allowing the blowing air J to flow through the right-side ventilation opening 9 and the left-side ventilation opening 10. The state in which the blowing air J does not flow through the canter ventilation opening 8 and flows through the right-side ventilation opening 9 and the left-side ventilation opening 10 is called a side ventilation bleed, which is used for improving the comfort in a vehicle interior.

In order to positively execute the side ventilation bleed, the partition portions 15 and 16 on which the defroster/ventilator door 23 abuts are required to resist a certain stress. Accordingly, the partition portions 15 and 16 are required to have a certain length (a length corresponding to the flow of the blowing air J in the ventilator blow-off ports 8, 9 and 10 which is, for example, 10 mm or more and 30 mm or less). On surfaces on the downstream side of the center ventilation opening 8, the right-side ventilation opening 9 and the left-side ventilation opening 10, not-shown ducts are respectively attached, and the partition portions 15 and 16 ere required to have a certain width (a width along the right and left direction of the vehicle which is, for example, 10 mm or more and 20 mm or less) in order to positively prevent the leakage of the blowing air J split by the partition portions 15 and 16.

Next, when the position of the defroster/ventilator door 23 is changed and the rate of the blowing air J blowing off from the ventilator blow-off ports 8, 9 and 10 is the maximum, the partition portions 15 and 16 become ventilation resistive elements with respect to the blowing air J as they are portions having a certain width, which has been a factor of reducing the air volume and the occurrence of noise.

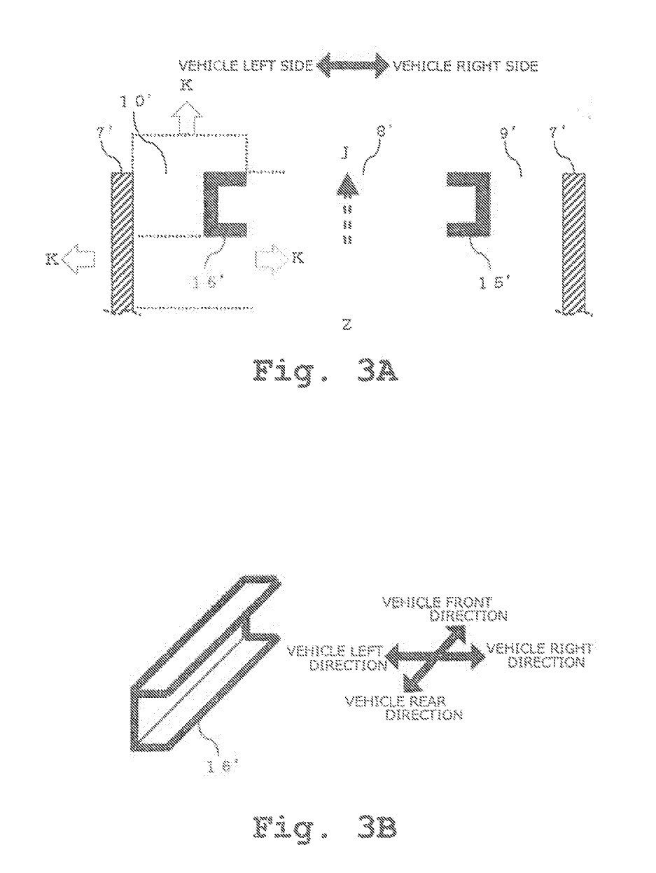

FIGS. 3A and 3B are schematic views of cross sections showing a partition portion of a related-art ventilator blow-off port taken along a surface including I-I line in FIG. 1 and corresponding so a surface extending in the vertical direction of the vehicle and the right and left direction of the vehicle or taken along a surface corresponding to a surface extending in the vertical direction of the vehicle and the right and left direction of the vehicle in the ventilator blow-off ports 8, 9 and 10 in FIG. 2 in the related-art vehicular air conditioner. The partition portions are configured to have a certain stress for preventing deformation with respect to the abutting of the defroster/ventilator door 23, to have a certain width for positively preventing the leakage of the blowing air J split by partition portions 15′ and 16′ and to have C-shaped cross sections for enabling the production by the injection molding process. A symbol shown in FIG. 3A indicates a direction of removing the mold. The partition portions 15′ and 16′ of FIGS. 3A and 3B are the ventilation resistive elements with respect to the blowing air J, which becomes the factor of reducing the air volume and generating noise.

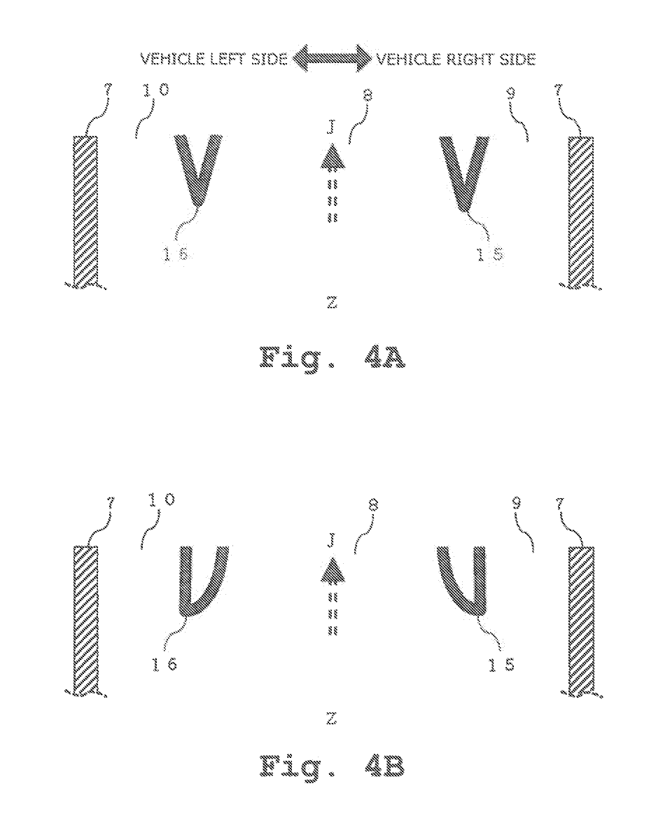

FIGS. 4A and 4B show the embodiment of the present invention. In cross sections of the vehicular air conditioner according to the present invention which are taken along the surface including I-I line in FIG. 1 and corresponding to the surface extending in the vertical direction of the vehicle and the right and left direction of the vehicle or taken along the surface corresponding to the surface extending in the vertical direction (an upper and lower direction on the paper) of the vehicle and the right and left direction (a depth direction on the paper) of the vehicle in the ventilator blow-off ports 8, 9 and 10 in FIG. 2, FIG. 4A shows a form where an outer contour line of the partition portion extends in an approximately V-shape from the upstream side to the downstream side of the air, FIG. 4B shows a form where the outer contour line extends to be widened to the end. In the cross-sectional shapes of the partition portions 15 and 16 both in the FIGS. 4A and 4B, the outer contour lines contacted by the blowing air J are smaller in the upstream side than in the downstream side of the blowing air J. The cross-sectional shapes of the partition portions 15 and 16 are not limited as along as the outer contour lines contacted by the blowing air J has the shape where the outer contour line extends to be widened to the end from the upstream side to the downstream side of the air. However, the outer contour line preferably extends in the approximately V-shape, an approximately U-shape or an approximately trapezoidal shape, and specifically, the shape shown in FIG. 4B is more preferable. The molding can be performed by adopting the direction of removing the mold shown in FIG. 3A.

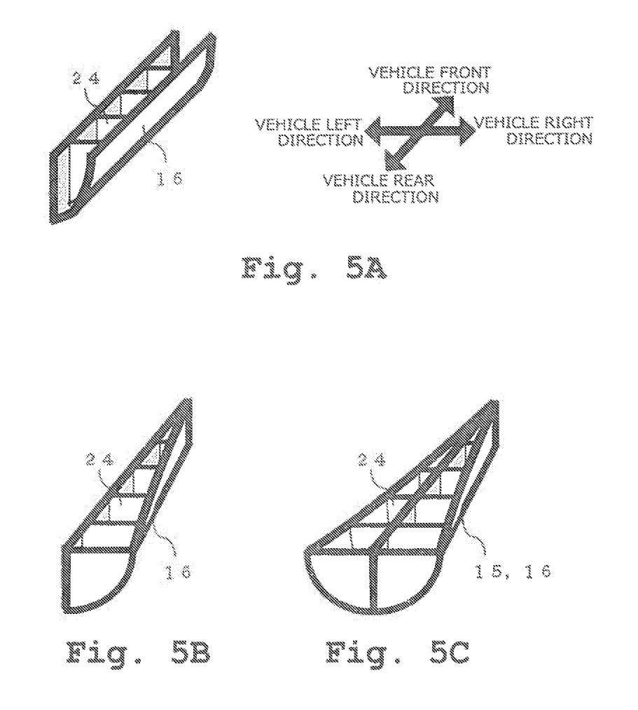

That partition portions 15 and 16 are preferably provided with ribs 24 as shown in FIG. 5A through it is not always essential. That is because a plurality of ribs formed inside the partition portions 15 and 16 can cover reduction in strength of the partition portions 15 and 16 caused by reduction in thickness of the casting 7 according to the demand of reduction in weight of the vehicular air conditioner, and can solve the constraints on design of the mold existing when the casing 7 having the ventilator blow-off ports 8, 9 and 10 is molded by monolithic injection molding. Supposing that the partition portions 15 and 16 are configured not to have the ribs 24 and to fill the entire inside of the outer contour with a resin material, not only the weight of the casing 7 is increased but also it may be difficult to form the outer contour to a desired shape due to deformation occurring in a cooling process after the injection molding process.

As shown in FIG. 5A, the shape of the partition portions 15 and 16 in the front and rear direction of the vehicle is not limited to the shape in which the cross sections shown in FIGS. 4A and 4B are uniformly forced in the front and rear direction of the vehicle. The partition portions 15 and 16 are required to resist the certain stress and to have the certain width, and further, to be able to be manufactured in the injection molding process as described above. The partition portions 15 and 16 are also required to abut on the defroster/ventilator doer 23 to allow the state of the side ventilation bleed to appear properly. It is preferable that the partition portions 15 and 16 are properly designed so as to fulfill the above requirements.

As a form for producing the same effect as the shape of the partition portions 15 and 16 in the front and rear direction of the vehicle, a method of forming a packing 25 on an abutting surface between the right-side ventilation partition portion 15/the left-side ventilation partition portion 16 and the defroster/ventilator door 23 is one of preferable embodiments. Materials for the packing are not particularly limited, and rubber state or spongy state resins are preferable to be used.

To form the abutting surface between the right-side ventilation partition portion 15/the left-side ventilation partition portion 16 and the defroster/ventilator door 23 to have a labyrinth structure in which the right-side ventilation partition portion 15/the left-side ventilation partition portion 16 and the defroster/ventilator door 23 are engaged, though not shown.

The structure in which the right-side ventilation partition portion 15 and the left-side ventilation partition portion 16 are formed in the ventilator blow-off ports 8, 9 and 10 in the horizontal air conditioner and the vertical air conditioner has been explained as the above, however, the present invention is not limited to the structure. For example, the partition portion having the structure of the present invention may be used when partitioning the defroster blow-off port 11. It is possible to secure the air flow rate of the blowing air J blown off from the defroster blow-off port 11 and to prevent noise.

The present invention can secure the air flow rate and can prevent noise by reducing the ventilation resistance generated in the partition portion of the vehicular air conditioner by the shape of the partition portion, therefore, the present invention is a technique capable of being applied to all the air conditioners having the partition portion.

### DESCRIPTION OF REFERENCE NUMERALS END SIGNS

1 vehicular air conditioner
2 blower unit
3 air conditioning unit
4 air blow duct
5A outside air inlet
5B inside air inlet
6A blower unit upper case
6B blower unit lower case
7 casing
7′ related-art casing
8 center ventilation opening
8′ related-art center ventilation opening
9 right-side ventilation opening
9′ related-art right-side ventilation opening
10 left-side ventilation opening
10′ related-art left-side ventilation opening
11 defroster blow-off port
12 front foot blow-off port
13 rear foot blow-off port
14 defroster partition portion
15 right-side ventilation partition portion
15′ related-art right-side ventilation partition portion
16 left-side ventilation partition portion
16′ related-art left-side ventilation partition portion
17 blower
18 filter
19 heat exchanger for cooling
20 heat exchanger for heating
21 air mix door
22 foot door
23 defroster/ventilator door
24 rib
25 packing
A blower housing portion
B air inlet passage
C heat exchanger for cooling setting space
D heat exchanger for heating setting space
E heat exchanger for heating bypass passage
F ventilation passage
G front foot passage
H rear passage
I defroster passage
J blowing air
K mold removing direction
Z air passage

What is claimed is:

1. A vehicular air conditioner comprising:
a casing provided with an air passage of blowing air thereinside and including an air blow-off port from which the blowing air is blown off:
a partition portion provided in the air blow-off port, splitting the blowing air into a plurality of air flows and having a cross-sectional shape which is smaller in an upstream side than in a downstream side of the blowing air; and
a door arranged inside the air passage so as to rotate and capable of shutting on the partition portion.

2. The vehicular air conditioner according to claim 1,
wherein the cross-sectional shape of the partition portion is any of the following:
an outer contour line contacted by the blowing air
(1) extends to be widened to the end,
(2) extends in an approximately V-shape,
(3) extends in an approximately U-shape, and
(4) extends in an approximately trapezoidal shape from the upstream side to the downstream side of the air.

3. The vehicular air conditioner according to claim 1,
wherein a plurality of ribs are formed inside the partition portion.

4. The vehicular air conditioner according to claim 1,
wherein the air blow-off port is a ventilator blow-off port, and
the partition portion splits the blowing air into airs flowing toward a center ventilation opening provided in the center of a vehicle, a right-side ventilation opening provided in the right side of the vehicle and a left-side ventilation opening provided in the left side of the vehicle.

5. The vehicular air conditioner according to claim 1,
wherein the air blow-off port is a ventilator blow-off port, and
the door is a defroster/ventilator door performing switching so that the blowing air is blown off from any of the ventilator blow-off port and a defroster blow-off port.

6. A vehicle equipped with the vehicular air conditioner according to claim 1.

7. A vehicle equipped with the vehicular air conditioner according to claim 2.

8. A vehicle equipped with the vehicular air conditioner according to claim 3.

9. A vehicle equipped with the vehicular air conditioner according to claim 4.

10. A vehicle equipped with the vehicular air conditioner according to claim 5.
